(19) United States
(12) Patent Application Publication
(10) Pub. No.: US 2013/0164067 A1
(43) Pub. Date: Jun. 27, 2013

(54) CARRIAGE ROLLER BAR POWER PROFILE

(71) Applicant: Bantwal Sandeep, Bangalore (IN)

(72) Inventor: Bantwal Sandeep, Bangalore (IN)

(21) Appl. No.: 13/333,278

(22) Filed: Dec. 21, 2011

(51) Int. Cl. B41J 11/44

(52) U.S. Cl. 400/76

(57) ABSTRACT

A printer is disclosed. The printer has a carriage that holds at least one print head. The printer measures the power used by a motor that drives the carriage along a roller bar during a printing operation. The printer displays an error message when the power used by the motor exceeds a threshold.

### BACKGROUND

Many types of printers use one or more printheads attached to a carriage. The carriage is moved back and forth across the media while printing swaths of ink. The media is advanced between each printed swath. The carriage is typically moved along a roller bar when printing the swaths of ink. When the roller bar becomes dirty or the lubrication on the bar is no longer adequate, the carriage may have difficulty moving along the roller bar. This may cause image quality defects or may be reported as a paper jam and cause a drop in productivity for the printer.

### BRIEF DESCRIPTION OF THE DRAWINGS

FIG. 1 is an isometric partial view of a printer 100 in an example embodiment of the invention.

FIG. 2 is a plot of the carriage position vs. the PWM signal to the motor in an example embodiment of the invention.

FIG. 3 is a flow chart in an example embodiment of the invention.

### DETAILED DESCRIPTION

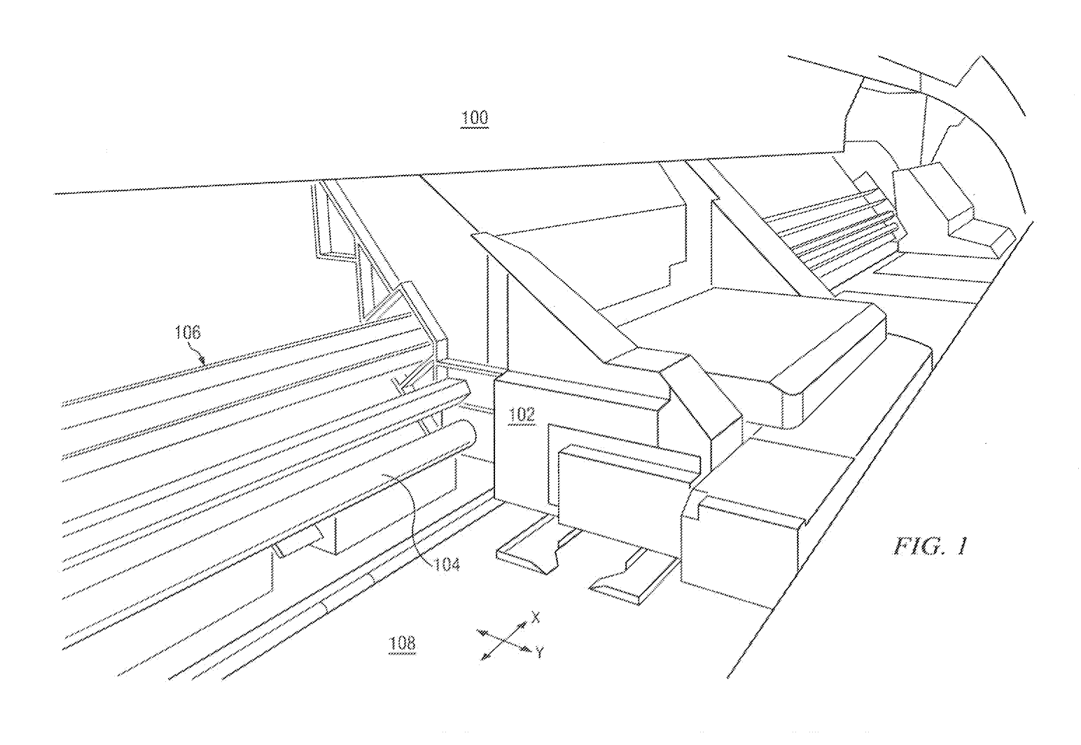

FIGS. 1-3, and the following description depict specific examples of the invention. For the purpose of teaching inventive principles, some conventional aspects have been simplified or omitted. Those skilled in the art Will appreciate variations from these examples that fall within the scope of the invention. The features described below can be combined in various ways to form multiple variations of the invention. As a result, the invention is not limited to the specific examples described below, but only by the claims and their equivalents.

FIG. 1 is an isometric partial view of a printer 100 in an example embodiment of the invention. FIG. 1 includes a carriage 102, roller bar 104, belt drive 106 and media 108. Carriage 102 contains one or more print heads. Carriage 102 is attached to, and slides along, roller bar 104 in the X axis. The print heads inside carriage 102 print swaths of ink onto media 108 as carriage travels along roller bar 104. Belt drive 106 is attached to carriage 102 and moves carriage 102 along roller bar 104. Media 108 is underneath carriage 102 and is advanced in the Y axis after each swath of ink is printed. A linear encoder is positioned adjacent carriage 102 and tracks the position of carriage along roller bar 104. A motor (not shown for clarity) is attached to belt drive 106 and supplies motive force to belt drive.

A controller (not shown for clarity) is located inside printer 100 and is coupled to the linear encoder, the motor, and the carriage. The controller operates a closed loop feedback system to move the carriage 102 along the roller bar 106. The controller can include memory, a processor, an application specific integrated circuit (ASIC) or the like. The carriage movement is controlled by a Pulse Width Modulation (PWM) technique. Whenever the motor experiences higher resistance to carriage movement, a higher PWM signal is sent to the motor to overcome the resistance and to maintain a constant carriage speed. A higher PWM signal received by the motor creates a higher force from the motor.

Ideally the carriage roller bar 104 is very smooth and lubricated and the carriage will slide over it using a constant motor force. Therefore when the resistance against the carriage is constant from one end of the roller bar to other end, and the carriage is moving at a constant speed, the applied PWM signal will be uniform. During use, the roller bar 104 can become dirty or the lubrication may degrade. As the roller bar becomes dirty, the force required to move the carriage along the roller bar 104 increases. The location of resistance build-up on the roller bar can be located by examining the PWM signal profile for a carriage as it moves from one end of the roller bar to the other end.

FIG. 2 is a plot of the carriage position vs. the PWM signal to the motor in an example embodiment of the invention. The X axis of the plot is the carriage position along the roller bar 104. The Y axis is the PWM signal. Plot 210 is a running average of the PWM signal sent to the motor at each position of the carriage along the roller bar. In this example the running average is over one inch of the position of the roller bar, but in other examples the running average may be based on a different length along the roller bar.

Line 212 is a threshold PWM level. Along most of the plot the PWM signal runs from a low of 3300 to a high near 4100. At position 21 there is a spike in the PMW signal where the PMW signal reaches above 7000. The spike at position 21 is above the threshold value 212. This spike in the PWM signal indicates a position on the roller bar of increased resistance. The increased resistance may be due to dirt or ink accumulated on the roller bar, or a lack of lubrication at that point on the roller bar. In either case, maintenance of the roller bar may be required.

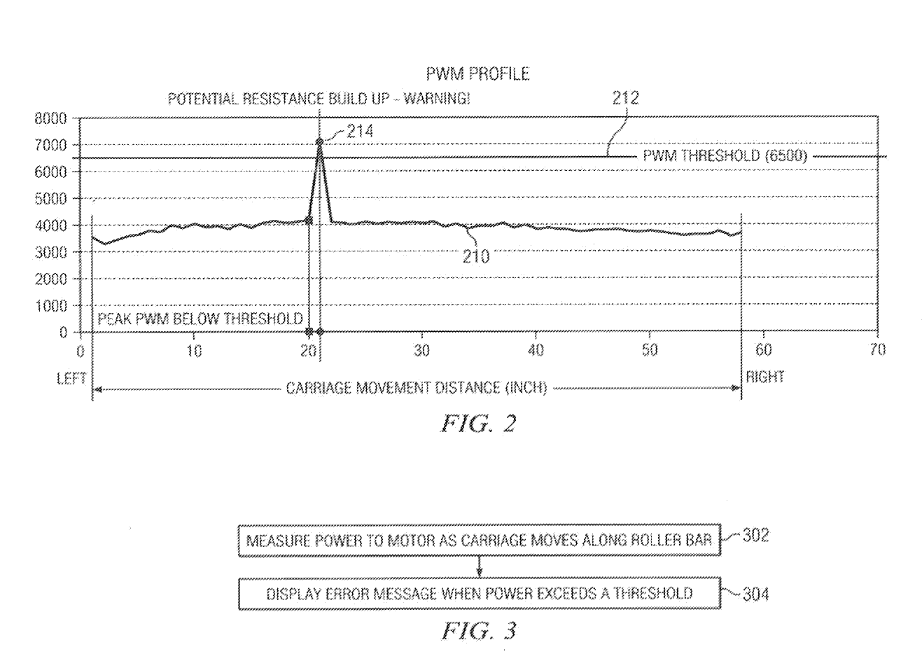

FIG. 3 is a flow chart in an example embodiment of the invention. At step 302 the power to the motor is measured as the carriage is moved along the roller bar. At step 302 an error message is displayed when the power to the motor exceeds a threshold.

The threshold can be selected using a number of different methods. In one method the PWM signals from a number of different printers can be measured. The threshold can be selected to be higher, by some margin, than the highest measured PWM signal. In other examples, the PWM signal for each printer can be measured at the factory. The threshold can be selected to be above the factory measured maximum PWM signal for each printer by some pre-selected amount.

Threshold 212 is shown as a straight line with the same threshold level for each carriage position along the roller bar. In other examples, threshold 212 may not be a constant amount, but may have a profile and vary along the length of roller bar 212. Other factors may cause an increase in the resistance to carriage movement, for example carriage belt damage, damaged motor, or any obstacle restricting the movement of the ink tubes along with the carriage. Some of these problems may develop during use and some may be dependent on the manufacturing process. In some examples the profile of the PWM signal may be measured once the printer has been built. The threshold will be based on the measured profile and will vary along the length of the roller bar. In this way only increases in the resistance of the movement of the carriage will cause the PWM signal to exceed the threshold amount.

As the printer is used in the field, the resistance against carriage movement may increase due to ware. As the PWM profile changes over time, the threshold profile may also be changed over time to accommodate the increase in resistance due to ware. The threshold profile may be increased to match the ware profile, but spikes or sudden increases in power usage in the ware profile may not be transferred to the new threshold profile.

When the PWM signal does exceed the threshold, the user is notified that the printer needs maintenance. The user may be notified by displaying a notification or error message on the printer's display. In other examples the printer may be attached to the Internet using an internal I/O card and may be managed remotely. In this case the error message may be displayed remotely. In some cases the printer may have a cleaning and lubrication system. When the PWM signal exceeds the threshold the cleaning and lubrication system may be triggered to perform a cleaning and lubrication operation on the roller bar.

In some examples the notification message may contain a number of pieces of information. For example, the notification message may include the location where the PWM signal exceeded the threshold, the average PWM signal, a plot of the PWM signal or the like.

In one example embodiment of the invention, the PWM signal is tracked every time the printer prints a swath of ink. In other examples, the printer may only track the PWM signal during selected times during a print job, for example only when printing the first swath of ink or only after so much media has been printed.

Using a PWM signal to control the power to the motor for the carriage drive system is only one of many methods for varying power to a motor. Other methods for tracking the power used during carriage movement may be used for detecting error conditions in the printer.

What is claimed is:

1. A printer, comprising:
a carriage having at least one printhead, the carriage attached to a roller bar where the carriage slides back and forth along the roller bar;
an encoder coupled to the carriage and indicating the position of the carriage along the roller bar;
a drive system coupled to the carriage to move the carriage along the roller bar, the drive system having a motor;
a controller coupled to the motor and the encoder to control the position of the carriage along the roller bar;
the controller tracking the power to the motor as the carriage moves along the roller bar, the controller displaying a message on a display when the power to the motor exceeds a threshold.

2. The printer of claim 1, wherein the power to the motor is tracked by using a pulse width modulation (PWM) signal.

3. The printer of claim 1, wherein the threshold is based on a pulse width modulation (PWM) profile of the printer measured during manufacturing of the printer.

4. The printer of claim 1, further comprising:
an I/O card to connect the printer to the Internet, wherein the display is remote from the printer.

5. The printer of claim 1, wherein the message includes the location on the roller bar where the power exceeded the threshold.

6. The printer of claim 1, wherein the power to the motor is not tracked every time the carriage prints a swath of ink.

7. The printer of claim 1, further comprising:
a cleaning and lubrication system, wherein the cleaning and lubrication system is triggered to perform a cleaning and lubrication operation on the roller bar when the power exceeds a threshold .

8. A method for printing, comprising:
measuring the power to a motor as the motor drives a print carriage along a roller bar during a print operation;
displaying a message on a display when the power to the motor exceeds a threshold as the carriage is moved along the roller bar.

9. The method for printing of claim 8, wherein the message contains the location where the power to the motor exceeded the threshold.

10. The method for printing of claim 8, wherein the message is displayed remote from the printer.

11. The method for printing of claim 8, wherein the power to the motor is varied using a PWM signal.
